(19) United States
(12) Patent Application Publication
(10) Pub. No.: US 2011/0036506 A1
(43) Pub. Date: Feb. 17, 2011

(54) SYSTEM FOR CONTINUOUSLY USING RESIST STRIPPER LIQUID BASED ON NANOFILTRATION

(75) Inventors: Masanao Sumita, Nagoya-shi (JP); Hideo Hayashi, Nagoya-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOAGOSEI CO., LTD.

(21) Appl. No.: 12/667,300

(22) PCT Filed: Jun. 27, 2008
(86) PCT No.: PCT/JP08/61694

§ 371 Date: Dec. 30, 2009

(30) Foreign Application Priority Data
Jul. 3, 2007 (JP) 2007-175648

(51) Int. Cl. B32B 38/10

(52) U.S. Cl. 156/584

(57) ABSTRACT

The objective of the present invention is to realize a system in which a resist stripper liquid used in resist stripping is regulated so as to have a resist component concentration within a certain concentration range even when the resist stripper liquid is continuously used for a long time without replacing it. In stripping a positive resist with a stripper liquid, the resist components dissolving in the stripper liquid can be diminished by cross-flow filtration with a specific ceramic filter (5). In the resist stripping system, a resist-component-containing stripper liquid resulting from a stripping step is treated in a filtration step, and the resultant concentrated stripper liquid having a heightened resist-component concentration is suitably discharged from the system. A fresh stripper liquid is suitably added to the stripper liquid from which the resist components have been removed, and the resultant stripper liquid is reused in the stripping step.

### FIELD OF THE INVENTION

The invention relates to a system for resist stripping while treating a resist stripper liquid containing a resist component in a resist stripping step carried out in a process for the production of electronic components such as semiconductors, liquid crystal devices and printed wiring boards.

### BACKGROUND ART

In a process for the production of electronic components such as semiconductors, liquid crystal devices and printed wiring boards, there are provided an irradiation step for irradiating a light or the like through a pattern-mask after forming a photo-sensitive film called photoresist or simply resist on a substrate laminating semiconductor films on the surface of a Si wafer or a glass, a developing step for dissolving an unnecessary photoresist with a developer, and a stripping step for stripping a remaining resist film. In the stripping step, a resist stripper liquid is generally used for stripping the remaining resist film.

In association with miniaturization of electronic components, a positive type resist is generally used in which the portion exposed to a light is solubilized in a developer, because it can comply with finer pattern shape than a negative type resist. And a limited kind of organic solvent such as N-methyl-2-pyrrolidone (NMP), dimethylsulfoxide (DMSO) or an amine is generally used as the stripper liquid. When such a resist stripper liquid is used, a resist film provided on the substrate is stripped from the substrate and transferred to the resist stripper liquid.

There are many views regarding the mechanism of dissolution of a resist film including a case where a resist film is completely separated into a low molecular weight component by the stripper liquid, a case where a resist film swollen by the resist stripper liquid becomes small pieces and disperses in the stripper liquid, and the like. Hereafter, these cases are collectively referred to as the dissolution of a resist in a stripper liquid, and the resist transferred to the stripper liquid is referred to as a resist component.

It is known that a stripper liquid containing a resist component even at a small amount of 0.1% to 5% by weight significantly reduces the stripping rate of a new resist film. Therefore, replacing all or a part of the stripper liquid is generally carried out after stripping a certain amount of the resist to keep the stripping rate in a specific range. However, in this method, there were problems such as a high cost required for purchasing a fresh liquid and treating the waste liquid, because a large amount of the waste liquid is generated at every time of replacing the stripper liquid and the fresh liquid is used in a large amount, and an adverse effect on the environment.

When an alkaline stripper liquid represented by the amine type stripper liquid comprising an organic amine such as mono-ethanolamine is used, the dissolved resist component and the amine form a salt and hence the decrease of the resist stripping rate tends to be small against the dissolved amount of the resist component. There were problems such as odor of the amine and the fast degradation of the stripper liquid itself because the amine is chemically unstable. For this reason, recently, a non-amine type stripper liquid without containing an alkaline component such as amine is recently attracting attention. However, when the non-amine type stripper liquid is used, the resist stripping rate tends to be decreased due to a resist component dissolved in the stripper liquid, leading problems such as a high cost required for replacing the stripper liquid to maintain the stripping rate.

For the above-mentioned problems, reduction of the waste liquid has been attempted by treating and reusing the resist stripper liquid containing the resist component. In Patent Document 1, it is disclosed that the resist component dissolved in the waste liquid after stripping the resist with a stripper liquid containing alkanol amine can be reduced by filtration using nanofiltration membrane having a fractional molecular weight in the range from 100 to 1,500. The nanofiltration membrane having such a fractional molecular weight is commonly a membrane whose main component is organic substance, as described in specific example of Patent Document 1. The drawback of the organic-based membrane includes: difficulty in increasing filtration rate by applying pressure due to low pressure resistance; tendency to swell and deteriorate due to stripper components, low heat resistance property, and the like. Originally, organic-based membrane for nanofiltration is a derivative of an ultrafiltration membrane used for artificial dialysis, cleanup of water and the like, and is liable to cause problems such as deterioration for an organic solvent though it has sufficient strength and stability in a water system.

In the paragraph [0018] of Patent Document 1, it is disclosed that when a film having fractional molecular weight of 1500 and more is used as the above-mentioned nanofiltration membrane, the resist dissolved in the stripper liquid cannot be removed. Additionally, in the paragraph [0012] of Patent Document 2, as the solvent-resistant filter, a ceramic filter that is made of alumina, zirconia, silicon carbide, silicon nitride, carbon or the like and has a mean pore size of approximately 0.04 to 2 μm, a metal filter that is made of Mottmetal or the like and has a mean pore size of approximately 0.01 to 1 μm, and further a solvent resistant polymer film such as a film made of fluoropolymer or the like are described. However, a film having a small pore that can capture a fine molecule having the fractional molecular weight of less than 1,500 and having a sufficient runoff velocity has not been realized.

[Patent Document 1] JP-A 2003-167358

[Patent Document 2] JP-A H05-253408

### DISCLOSURE OF THE INVENTION

### Problems that the Invention is to Solve

When the stripping of a positive type resist is performed using a stripper liquid, the concentration of the resist component in the stripper liquid increases and the stripping rate for new resist films is affected. Therefore, the stripper liquid must be replaced frequently by the person in charge of the resist stripping. The objective of the present invention is to realize a system in which a resist stripper liquid used in resist stripping is regulated so as to have a resist component having a certain concentration range even when the resist stripper liquid is continuously used for a long time without replacing the liquid.

### Means for Solving the Problems

The inventors have found that the resist component dissolved in the stripper liquid can be reduced by carrying out cross-flow filtration through a specific ceramic filter at the time of stripping of the positive type resist using the stripper liquid. And the inventors has completed a resist stripping system wherein a concentrated stripper liquid in which the dissolved resist component is concentrated, obtained by treating in the filtration step, a stripper liquid containing the resist component generated in the stripping step is discharged from the system as necessary, and a stripper liquid in which a fresh stripper liquid is added to a treated stripper liquid from which the resist component is removed is used again in the stripping step.

### EFFECT OF THE INVENTION

When the present invention is applied to the resist stripping on a substrate for liquid crystal devices, semiconductors and the like, the resist stripping can be carried out while keeping the concentration of the resist component dissolved in the stripper liquid in a certain concentration range for a long time without using a large amount of fresh liquid and generating a large amount of waste liquid. Therefore, the resist stripping of low cost with less environmental burden and stable quality can be realized.

### BEST MODE FOR CARRYING OUT THE INVENTION

A resist stripper liquid containing an organic compound in an amount of 80% or more by weight based on 100% by weight of the total of the liquid, available in the present invention is either an amine-based type containing an amine or an alkaline, or a non-amine-based type without containing an amine and an alkali and having pH of 9 or less, and may contain water in an amount less than 20% by weight. In the amine-based type, general organic stripper liquids containing an alkanol amine can be used. Examples of the specific alkanol amine include monoethanolamine, monoisopropanolamine, 2-(2-aminoethoxy)ethanol, N-methylethanolamine and the like. The preferred is monoethanolamine. One kind of amine may be used singly or a mixture of several kinds of amines may be used mixing with other organic solvent or water. A stabilizing agent, a corrosion inhibitor and the like may be incorporated. The organic solvent is a collective term for organic compounds which are liquid at the normal temperature and have an ability to dissolve other substances.

For the non-amine-based stripper liquid, a non-volatile polar solvent such as carbonate ester, dimethylsulfoxide, an alkylpyrrolidone, a dialkylsulfone, an alkylacetamide, sulfolane and an alkylbutyrolactone can be used. Here, non-volatile means characteristic in which the vapor pressure at 25° C. is 0.67 kPa or less, and the polar solvent means that the SP value is 8 or greater. The preferable is a case to use one of the group 1 consisting of N-methyl-2-pyrrolidone, N-ethyl-2-pyrrolidone and dimethylsulfoxide singly, and a case to use plural compounds selected from the group 2 consisting of N-methyl-2-pyrrolidone, N-ethyl-2-pyrrolidone, dimethylsulfoxide, N,N-dimethylformamide, N,N-dimethylacetoamide, γ-butyrolactone, sulfolane, ethylene carbonate and propylene carbonate. This mixed stripper liquid is preferably one containing N-methyl-2-pyrrolidone or N-ethyl-2-pyrrolidone in an amount of 20% or more by weight. It is noted that N-methyl-2-pyrrolidone and N-ethyl-2-pyrrolidone are cyclic amides, and are not amines.

The non-amine-based stripper liquid is preferably one in which at least one kind selected from the group 3 consisting water, an alkylalcohol and an alkylether is further incorporated. In the case, the content of the compound of the group 3 is preferably 40% or less by weight. As for water, the content is preferably 20% or less by weight based on the total liquid.

The pH value of the stripper liquid is measured by inserting a glass electrode, according to “General rule for test methods of reagents” prescribed in 5.5 of JIS-K 8001 in 100 ml of the solution prepared by taking 10 g of the stripper liquid by adding water containing no carbon dioxide. When the mixed solution is separated into two layers, the pH is measured by inserting a glass electrode in the water layer. The pH value of the amine type stripper liquid may be more than 9. The pH value of the non-amine type stripper liquid is essentially 9 or less, however, the value is preferably 4 or more and 9 or less, and more preferably 5 or more and 8.5 or less. It is because the liquid with too small pH values may cause corrosion of the metal.

A resist which can be eliminated with the resist stripper liquid used in the present invention is one called positive type resist. And it is one wherein the portion that is formed on the substrate in a film shape and then is exposed to a light in the exposing step is a kind of substance which changes so it dissolves when it comes in contact with a developing solution. The resist film which is not exposed to a light remains on the substrate after development, and is eliminated from the substrate in the stripping step after acting to protect the surface of the substrate in the manufacturing step of electronic components.

Examples of the positive type resist include one produced by dissolving an alkali-soluble resin and a photosensitizing agent consisting of a naphthoquinone diazide sulfonic acid ester of polyhydroxybenzophenone in an organic solvent. Examples of the alkali-soluble resin include a novolac resin such as a phenol novolac resin and a cresol novolac resin, a polyvinylphenol and the like. Examples of the photosensitizing agent include an ester obtained using a 1,2-naphtoquinonediazide-5-sulfonic acid compound or a 1,2-naphtoquinonediazide-4-sulfonic acid compound and a polyhydroxyaromatic compound, and the like. Examples of the organic solvent include an ester such as butyl acetate and ethyl lactate, a glycolether acetate such as ethylene glycol monomethylether acetate and propylene glycol monomethylether acetate, an aromatic hydrocarbon such as toluene and xylene, a ketone such as methylethylketone and cyclohexanone, and the like. The positive type resist is coated on the substrate using a spin coater, a roll coater or the like so as to have a suitable thickness, and patterning is carried out in the exposing and developing step after pre-heating generally called as prebaking. The prebaking condition is heating at a temperature of preferably 80° C. or higher and lower than 140° C. for 2 minutes or longer and 30 minutes or less.

In the present invention, generally known all positive type resists other than the above-mentioned ones can be applied.

The filter which is an important constituent of the present invention is not particularly limited so long as it is a ceramic porous body consisting of a ceramic compact and can pass the above-mentioned stripper liquid can be used. A filter having a small mean pore size and too small fractional molecular weight can provide a high stopping ratio but not a sufficient filtration rate because the stripper liquid containing the resist component becomes difficult to pass through the filter. Additionally, in the case of a filter having a large mean pore size and too large fractional molecular weight, the stopping ratio becomes lower. Therefore, the concentration of the resist component in the filtrate that passes through the filter, namely in the treated stripper liquid becomes higher and the concentration of the resist component in the treated stripper liquid cannot be lowered sufficiently. In the present invention, a filter having a mean pore size D defined by the following formula 1 of 3 nm or more and 5 nm or less, and particularly 4 nm or more and 5 nm or less, the fractional molecular weight from 1,500 to 4,000, and particularly from 2,000 to 4,000 is excellent in the balance between stopping ratio and filtration rate. In the case of an amine type stripper liquid, a filter having a mean pore size D of 2 nm or more and 4 nm or less and the fractional molecular weight from 1,000 to 2,000 is especially excellent. Since the molecular weight of the resist component becomes smaller in the amine type stripper liquid, preferable pore size becomes smaller as compared with the case of non-amine type.

A mean pore size D=4V/A <Formula 1>

Assuming the shape of the fine pore as a cylinder, the value D=4V/A obtained by dividing the total pore volume (V=πD²L/4) with the total surface area (A=πDL) is defined as the mean pore size. Here, V is a total volume of all fine pores, and L is a mean depth of the fine pores, each can be measured by the mercury intrusion porosimetry method.

The fractional molecular weight is defined using polyethylene glycol with known molecular weight as “minimum molecular weight of polyethylene glycol (an aqueous solution) which can be inhibited at 90% or more in the film” expressed in Dalton.

The material of the above-mentioned filter is not particularly limited so long as it is a general ceramic such as alumina, zirconia, titania, mullite, cordierite, silicon carbide and silica. Any of these ceramics can be used. Among these, α-alumina, zirconia and titania are preferable due to excellent mechanical strength and chemical stability. These ceramics can be used singly or in a combination, and can be coated on the surface of different kind of frameworks. The most preferable one for this application is one with coating of titania on the framework of α-alumina. In this case, so far as the upper-surface is coated with titania, preferable one can be obtained irrespective of the thickness of the coating.

The shape of the above-mentioned filter may be flat, tubular or spiral type and any of these can be preferably used. Further, in order to improve pressure resistance, a support made of other material may be in contact with the filter. In the case where the filtration is performed using the filter, especially when the fractional molecular weight of the filter is small and a differential pressure is applied, it is possible to increase the filtration rate. In the present invention, the filtration is carried out by applying the differential pressure of 0.1 MPa or more and 3 MPa or less, and further preferably 0.2 MPa or more and 2 MPa or less. Here, the differential pressure means the difference of the pressure of the liquid side before filtration (in the invention, the stripper liquid containing the resist component) and the pressure of the liquid side after filtration (in the invention, the treated stripper liquid) sandwiching the filtration face.

There are many filtration methods using a filter. In the present invention, a cross-flow filtration is used. There is an advantage in the cross-flow filtration that formation of the thick cake of the precipitated and accumulated resist component on the filter is prevented since the stripper liquid containing the resist component flows in the direction parallel to the filter face. Based on this principle, the stripper liquid flowing on the filter is preferable to have a flow rate above a certain level in the direction parallel to the filter face. The flow rate varies depending on the pressure applied to the stripper liquid the composition of the stripper liquid, temperature and the like. However, the optimum upper limit of the flow rate of the stripper liquid in the direction parallel to the filter face in the system according to the present invention is 20 m/s. If the flow rate is less than 0.1 m/s, clogging is liable to occur. And if the flow rate is too high, loss of energy is large. The preferable flow rate is in the range from 0.5 m/s to 10 m/s. Additionally, the flow rate of the stripper liquid containing the resist component that passes through the filter, namely the filtrate flow rate is preferably 3 L/(h·m²) or higher, more preferably 6 L/(h·m²) or higher, and further preferably 11 L/(h·m²) or higher. (The unit represents the amount of the liquid (litter) passes through in 1 hour per filtration area (m²) of the filter. The reason why the higher filtration flow rate is preferred is that a larger amount of the liquid can be treated with a filter having a smaller area, and is economical.

According to the present invention, a filtrate (a treated stripper liquid) with the stopping ratio of 70% or greater is obtained by the above-mentioned cross-flow filtration. The stopping ratio is defined by the following formula 2. For example, the stripper liquid in which the resist component is dissolved at 2% by weight in the first step (resist stripping process) and transferred to the second step becomes the treated stripper liquid with the resist concentration of 0.6% or less by weight after passing thorough the filter, and at that rate the concentration of the resist component in the stripper liquid at the side of the residue becomes high.

Stopping ratio=[(resist component concentration of the stripper liquid before filtration−resist component concentration of the stripper liquid passed through the filter)/(resist component concentration of the stripper liquid before filtration)]×100(%). <Formula 2>

When stripping and regeneration are repeated without replacing the stripper liquid, the resist component concentration in the entire stripper liquid becomes high. When the concentration of the resist component in the stripper liquid passed through the filter, namely in the treated stripper liquid reaches 2% by weight, if the stopping ratio is 70% or more, the concentration of the resist component in the stripper liquid containing the resist component before filtration becomes as high as approximately 6.7% or more by weight according to the formula 2. In this case, it is possible to always suppress the concentration of the resist component in the stripper liquid used continuously for the stripping of the resist at 2% or less by weight by adding a fresh stripper liquid to the treated stripper liquid in the third step, and by discharging from the system a concentrated stripper liquid at regular time intervals or at a certain flow rate before re-supplying the concentrated stripper liquid to the second step in the fourth step. If the concentration of the resist component exceeds 2% by weight, the striping rate of the resist is lowered excessively. On the contrary, in order to move the concentration of the resist component closer to 0, a large amount of a fresh stripper liquid must be added. Therefore, the concentration of the resist component in the treated stripper liquid is preferably in the range from 0.01% to 2% by weight, and more preferably from 0.05% to 1.0% by weight.

In addition, the condition of the above-mentioned constant interval or constant flow rate is not particularly limited so far as the concentration of the resist component in the resist stripper liquid can be kept at 2% or less by weight. For example, the constant interval may be set in the range from 0.1 to 300 hours, and is preferably from 1 to 10 hours. The condition of the constant flow rate may be from the flow rate that discharges 0.1% of the total amount of the stripper liquid present in the system in 1 hour to the flow rate that discharges 10% of the total amount of the stripper liquid present in the system in 1 hour, and is preferably from the flow rate that discharges 0.5% of the total amount of the stripper liquid to the flow rate that discharges 5% of the total amount of the stripper liquid in 1 hour.

The concentration of the resist component in the resist stripper liquid is generally measured by the residue of ignition. In the case where it is necessary to know the concentration in real time using the apparatus as in the present invention, electric measurements such as dielectric constant and conductivity, optical measurements such as refraction index and infrared transmittance, and the like are suitably applicable. When the concentration of the resist component in the stripper liquid obtained by these methods is reflected in the addition rate of the fresh stripper liquid, the discharge rate of the concentrated stripper liquid, filtration pressure, cross-flow rate and the like in the system, it is possible to carry out the resist stripping continuously, keeping the concentration of the resist component in the stripper liquid in the above-mentioned preferable range.

### EXAMPLE

Hereinafter, the present invention is described in detail using Examples and Comparative examples. The present invention is in no way limited by these examples. In addition, “%”, “ppm” and “part” are “% by weight”, “ppm by weight” and “part by weight”, respectively.

Examples according to the present invention can be carried out using the resist stripping system shown in FIG. 1. FIG. 1 is a system provided with the first step (the resist stripping step) comprising using three stripping tanks and the second step (the filtration step) comprising using a tank for circulating the concentrated stripper liquid, a ceramic filter and the like. The substrate attached with the resist film is supplied to the shower unit of the stripping tank 1, and then supplied to the stripping tank 2 and the stripping tank 3. The resist film is stripped by showering the stripper liquid circulating from each stripping tank three times in total. The resist stripper liquid used in the stripping tanks 1 to 3 is accumulated in the stripping tanks 1 to 3, respectively. The stripper liquid accumulated in the stripping tank 3 is transferred to the stripping tank 2 by overflowing, the stripper liquid accumulated in the stripping tank 2 is transferred to the stripping tank 1 by overflowing, the stripper liquid accumulated in the stripping tank 1 is transferred to the tank for circulating the concentrated stripper liquid by overflowing, subsequently. In a stripper liquid transferred to the tank for circulating the concentrated stripper liquid, the resist component with relatively high concentration is dissolved, and the cross-flow filtration through the ceramic filter in the second step is carried out. The treated stripper liquid passed through the ceramic filter becomes a stripper liquid from which the resist component is removed at a rate comparable to the stopping ratio, and is directly supplied to the stripping tank 3. Thus, when the circulation of the resist stripping and cross-filtration is continued, the concentration of the resist component in the concentrated stripper liquid becomes high. The total amount of the stripper liquid in the apparatus is decreased for the reasons such as discharge of the concentrated stripper liquid, bringing out of the concentrated stripper liquid associated with the taking out of the substrate after the stripping of the resist, evaporation and the like. Therefore, the total amount of the liquid can be regulated and the concentration of the resist component in the stripper liquid can be 2% or less by weight by the third step for supplying unused fresh stripper liquid to the treated stripper liquid (practically, the stripper liquid in the stripping tank 3) suitably and the fourth step for discharging a stripper liquid whose concentration of the resist component is high at a certain flow rate or frequency before re-supplying it to said second step. In addition, the total amount of the stripper liquid at the start of operation was set at 900 liter in the following Examples and Comparative examples.

### Example 1

A positive type photoresist containing 25 parts of naphtoquinone diazide and 100 parts of a cresol novorac resin was coated on a glass substrate to prepare a glass substrate attached with a dried resist film of 5 μm in thickness. A resist stripper liquid with the composition shown in Table 1 was set in the resist stripping apparatus shown in FIG. 1. A tubler type ceramic filter having area of 1.2 m² obtained by coating titania onto an alumina aggregate with a mean pore size of 4 nm and a fractional molecular weight of 2,000 determined by polyethylene glycol was used as a filter. The flow rate of the concentrated stripper liquid in the direction parallel to the filter face on the filter face was set to 2 m/s, and the flow rate at the side of the stripper liquid after filtration was not regulated and left to the natural flowing out. The flowing pressure by the pump was set so that the pressure of a side of the stripper liquid containing the resist component at the filter was higher than that of a side of the treated stripper liquid by 0.1 MPa. Namely, the difference of the pressure was 0.1 MPa. Then, the above-mentioned glass substrate attached with the resist film was continuously supplied into the resist stripping apparatus to perform resist stripping at a liquid temperature of 40° C. At this time, a stopping ratio was calculated from both resist component concentrations in the stripper liquid containing the resist in FIG. 1 and in the treated stripper liquid in FIG. 1 using the formula 2. In addition, when water without containing carbon dioxide was added to 10 g of the resist stripper liquid shown in Table 1 to prepare a 100 ml solution, the solution was uniform, and the pH thereof was 8.0 by an electrode pH meter.

The concentration of the resist component in the stripper liquid was determined by measuring the residue on ignition by drying the stripper liquid extracted from the stripping tanks 1 to 3 in FIG. 1 at 150° C. for 1 hour.

TABLE 1
Composition of stripper liquid

| Component | Content (% by weight) |
|---|---|
| N-methyl-2-pyrrolidone | 50 |
| Ethylene carbonate | 50 |

TABLE 2
Concentration of the resist component in
stripping tank of Example 1

| | Operating time (min.) | | | | |
|---|---|---|---|---|---|
| | 0 | 100 | 1000 | 2000 | 3000 |
| Stopping ratio (%) | | 85 | 86 | 87 | 87 |
| Concentration in stripping tank 1 | 0 | 0.07 | 0.36 | 0.48 | 0.57 |
| Concentration in stripping tank 2 | 0 | 0.05 | 0.05 | 0.12 | 0.21 |
| Concentration in stripping tank 3 | 0 | 0.0 | 0.0 | 0.10 | 0.18 |
| Runoff velocity of the filtrate (L/h · m²) | 16 | 15 | 11 | 11 | 11 |

(Unit of the resist component concentration is % by weight.)

When the stripping step was continued while adding a fresh stripper liquid so that the amount of the stripper liquid in the system was not changed under the condition that the dissolution rate of the resist component into the stripper liquid calculated based on the treated amount of the glass substrate attached with the resist film was 1.39 g/min, the actually determined value of the stripper liquid taken out from the system attached to the substrate was 56 g/min, and the discharge rate of the concentrated stripper liquid was 0.3 kg/min, from after 100 minutes, the concentration of the resist component in the stripper liquid containing the resist component tended to gradually increase. However, from after 100 minutes to 3,000 minutes, the concentration values in all the tanks of the stripping tanks 1 to 3 were 2% or less as shown in Table 2. In addition, at 0 min. of operating time the concentration of the resist component in the stripper liquid containing the resist component and in the treated stripper liquid were the same 0, the stopping ratio was not calculated.

### Example 2

The resist stripping was carried out in the same operation method as Example 1 except using a ceramic filter made of the same material with the mean pore size of 2 nm and the fractional molecular weight of 1,000 as a filter.

TABLE 3
Concentration of the resist component in
stripping tank of Example 2

| | Operating time (min.) | | | | |
|---|---|---|---|---|---|
| | 0 | 100 | 1000 | 2000 | 3000 |
| Stopping ratio (%) | | 92 | 92 | 92 | 92 |
| Concentration in stripping tank 1 | 0 | 0.07 | 0.36 | 0.46 | 0.53 |
| Concentration in stripping tank 2 | 0 | 0.001 | 0.04 | 0.10 | 0.16 |
| Concentration in stripping tank 3 | 0 | 0.0 | 0.02 | 0.07 | 0.12 |
| Runoff velocity of the filtrate | 6 | 6 | 3 | 3 | 3 |
| (L/h · m²) | | | | | |

(Unit of the resist component concentration is % by weight.)

From the results in Table 3, the concentration of the resist component in the stripper liquid containing the resist component tended to gradually increase, from after 100 minutes. However, from after 100 minutes to 3,000 minutes, the concentration values in all of the stripping tanks 1 to 3 were 2% or less. Since the fractional molecular weight of the filter became small as compared with Example 1, the absolute amount of the resist component passing through the filter became small, and the value of the stopping ratio according to the formula 2 became large in the cross-flow operation. In addition, although the flowing rate of the filtrate at filtration became small, the value of the stopping ratio was large. Therefore, it is considered that the concentration of the resist component in the stripper liquid containing the resist component became somewhat low.

### Example 3

The resist stripping was carried out in the same operation method as Example 1 except using a ceramic filter made of the same material with the mean pore size of 5 nm and the fractional molecular weight of 4,000 as a filter.

TABLE 4
Concentration of the resist component in
stripping tank of Example 3

| | Operating time (min.) | | | | |
|---|---|---|---|---|---|
| | 0 | 100 | 1000 | 2000 | 3000 |
| Stopping ratio (%) | | 71 | 72 | 72 | 72 |
| Concentration in stripping tank 1 | 0 | 1.9 | 1.8 | 1.8 | 1.8 |
| Concentration in stripping tank 2 | 0 | 1.6 | 1.5 | 1.5 | 1.5 |
| Concentration in stripping tank 3 | 0 | 1.4 | 1.3 | 1.3 | 1.3 |
| Runoff velocity of the filtrate (L/h · m²) | 22 | 20 | 18 | 18 | 18 |

(Unit of the resist component concentration is % by weight.)

From the results in Table 4, the concentration of the resist component of the stripper liquid containing the resist component became nearly constant, from after 100 minutes. However, from after 100 minutes to 3,000 minutes, the concentration values in all of the stripping tanks 1 to 3 were larger as compared with Example 1, but 2% or less. Since the fractional molecular weight of the filter became large as compared with Example 1, the absolute amount of the resist component passing through the filter became large, and the value of the stopping ratio according to the formula 2 became small in the cross-flow operation. In addition, although the flowing rate of the filtrate at filtration became large, the value of the stopping ratio was small. Therefore, it is considered that the concentration of the resist component in the stripper liquid containing the resist component became high.

### Example 4

The resist stripping was carried out in the same operation method as Example 1 except setting the flow rate of the stripper liquid in the direction parallel to the filter on the filter face to 8 m/s, and the differential pressure to 0.4 MPa.

TABLE 5
Concentration of the resist component in
stripping tank of Example 4

| | Operating time (min.) | | | | |
|---|---|---|---|---|---|
| | 0 | 100 | 1000 | 2000 | 3000 |
| Stopping ratio (%) | | 85 | 85 | 87 | 87 |
| Concentration in stripping tank 1 | 0 | 0.07 | 0.38 | 0.49 | 0.58 |
| Concentration in stripping tank 2 | 0 | 0.05 | 0.05 | 0.13 | 0.21 |
| Concentration in stripping tank 3 | 0 | 0.0 | 0.03 | 0.10 | 0.17 |
| Runoff velocity of the filtrate (L/h · m²) | 18 | 16 | 13 | 13 | 13 |

(Unit of the resist component concentration is % by weight.)

From the results in Table 5, the concentration of the resist component in the stripper liquid containing the resist component tended to gradually increase, from after 100 minutes. However, from after 100 minutes to 3,000 minutes, the concentration values in all of the stripping tanks 1 to 3 were 2% or less, nearly the same values as Example 1. In addition, since the same filter as in Example 1 was used, the value of the stopping ratio according to formula 2 was nearly the same as in Example 1 in the cross-flow operation. Further, since the flow rate of the stripper liquid and the differential pressure were increased as compared with Example 1, the runoff velocity of the filtrate became large. It appears that there is no effect on the concentration of the resist component in the stripper liquid containing the resist component, so far as the flow rate and differential pressure are in a favorable range.

### Example 5

The resist stripping was carried out in the same operation method as Example 1 except using the resist stripper having the composition shown in Table 6. In addition, when water without containing carbon dioxide was added to 10 g of the resist stripper liquid to prepare a 100 ml solution, the solution was uniform. The pH thereof was measured using an electrode pH meter and proved to be 11.6.

TABLE 6
Composition of stripper liquid

| Component | Content (% by weight) |
|---|---|
| N-methyl-2-pyrrolidone | 50 |
| Monoethanolamine | 50 |

TABLE 7
Concentration of the resist component in
stripping tank of Example 5

| | Operating time (min.) | | | | |
|---|---|---|---|---|---|
| | 0 | 100 | 1000 | 2000 | 3000 |
| Stopping ratio (%) | | 73 | 74 | 74 | 74 |
| Concentration in stripping tank 1 | 0 | 1.8 | 1.7 | 1.7 | 1.7 |
| Concentration in stripping tank 2 | 0 | 1.4 | 1.3 | 1.3 | 1.3 |
| Concentration in stripping tank 3 | 0 | 1.3 | 1.2 | 1.2 | 1.2 |
| Runoff velocity of the filtrate (L/h · m²) | 8 | 8 | 7 | 6 | 6 |

(Unit of the resist component concentration is % by weight.)

As compared with Example 1, the stopping ratio was decreased, but was 70% or more. In addition, although the concentration of resist component in the stripper liquid containing the resist component was higher than that in Example 1, the resist stripping could be continued under the concentration condition of 2% or less.

### Example 6

The resist stripping was carried out in the same operation method as Example 5 except using a ceramic filter made of the same material with the mean pore size of 2 nm and the fractional molecular weight of 1,000 as a filter.

TABLE 8
Concentration of the resist component in
stripping tank of Example 6

| | Operating time (min.) | | | | |
|---|---|---|---|---|---|
| | 0 | 100 | 1000 | 2000 | 3000 |
| Stopping ratio (%) | | 76 | 77 | 78 | 79 |
| Concentration in stripping tank 1 | 0 | 1.0 | 1.0 | 1.2 | 1.3 |
| Concentration in stripping tank 2 | 0 | 0.8 | 0.8 | 1.0 | 1.1 |
| Concentration in stripping tank 3 | 1 | 0.6 | 0.6 | 0.7 | 1.0 |
| Runoff velocity of the filtrate (L/h · m²) | 5 | 4 | 3 | 3 | 3 |

(Unit of the resist component concentration is % by weight.)

Since the fractional molecular weight of the filter became small as compared with Example 5, the absolute amount of the resist component passing through the filter became small, and the value of the stopping ratio became large in the cross-flow operation. In addition, although the flowing rate of the filtrate at filtration became small, the value of the stopping ratio was large. Therefore, it is considered that the concentration of the resist component in the stripper liquid containing the resist component became somewhat low.

### Example 7

In Example 7, dependency of the resist stripping rate on the concentration of the resist component dissolved in the stripper liquid was tested. The glass substrate attached with the resist film used in Example 1 was dipped in the resist stripper liquid with the composition shown in Tables 1 or 6 kept at 40° C. in the tank. Then, the disappearing time of the resist film by the visual inspection was defined as the stripping time of the resist film, and the stripping rate was determined from the thickness of the resist film. Repeating this test, the obtained results of the stripping rate against the concentration of the resist component in the stripper liquid were shown in Table 9.

TABLE 9
Stripping rate by concentration of resist component in Example 7

| | Concentration of resist | | | | |
|---|---|---|---|---|---|
| | component (%) | | | | |
| | 0 | 0.5 | 1.0 | 2.5 | 5.0 |
| | Stripping rate | | | | |
| Type of stripping liquid | (μm/min.) | | | | |
| Table 1 | 60 | 60 | 20 | <5 | <5 |
| Table 6 | 60 | 60 | 30 | 10 | <5 |

The amine type stripper liquid in Table 6 tends not to be affected by the dissolved resist component as compared with the non-amine type stripper liquid in Table 1. It was shown that the stripping rate of the resist decreased rapidly when the concentration exceeds 2% for both cases.

### Comparative Example 1

The resist stripping was carried out in the same operation method as Example 1 except using a ceramic filter made of the same material with the mean pore size of 1 nm and the fractional molecular weight of 700 as a nanofilter.

TABLE 10
Concentration of the resist component in
stripping tank of Comparative Example 1

| | Operating time (min.) | | | | |
|---|---|---|---|---|---|
| | 0 | 100 | 1000 | 2000 | 3000 |
| Stopping ratio (%) | | 97 | 97 | 97 | 97 |
| Concentration in stripping tank 1 | 0 | 1.3 | 2.1 | 2.8 | 3.1 |
| Concentration in stripping tank 2 | 0 | 1.2 | 2.0 | 2.6 | 2.9 |
| Concentration in stripping tank 3 | 0 | 1.1 | 1.8 | 2.4 | 2.7 |
| Runoff velocity of the filtrate (L/h · m²) | 2 | 1 | 0.5 | 0.5 | 0.4 |

(Unit of the resist component concentration is % by weight.)

Since the fractional molecular weight was out of the range of the present invention and became too small, the stopping ratio became larger than that in Example 1. However, the concentration of the resist in the stripper liquid containing the resist component became high rapidly, and exceeded 2%. The reason is considered that the runoff velocity of the filtrate became extremely small.

### Comparative Example 2

The resist stripping was carried out in the same operation method as Example 1 except using a ceramic filter made of the same material with the mean pore size of 10 nm and the fractional molecular weight of 10,000 as a nanofilter.

TABLE 11
Concentration of the resist component in
stripping tank of Comparative Example 2

| | Operating time (min.) | | | | |
|---|---|---|---|---|---|
| | 0 | 100 | 1000 | 2000 | 3000 |
| Stopping ratio (%) | | 45 | 47 | 47 | 47 |
| Concentration in stripping tank 1 | 0 | 2.9 | 2.8 | 2.8 | 2.8 |
| Concentration in stripping tank 2 | 0 | 2.5 | 2.4 | 2.4 | 2.4 |
| Concentration in stripping tank 3 | 0 | 2.4 | 2.3 | 2.3 | 2.3 |
| Runoff velocity of the filtrate (L/h · m²) | 28 | 27 | 25 | 25 | 25 |

(Unit of the resist component concentration is % by weight.)

Since the fractional molecular weight was out of the range of the present invention and became too large, the stopping ratio became larger than that in Example 1. However, it is considered that the stopping ratio became extremely small and the concentration of the resist in the stripper liquid containing the resist component became high exceeding 2%.

### Comparative Example 3

The resist stripping was carried out in the same operation method as Example 1 except using a polyamide filter with the fractional molecular weight of 2,000 as a nanofilter.

Since an organic filter was used, at 5 minutes after starting operation, it became impossible to apply the differential pressure between the concentrated stripper liquid line and the treated stripper liquid line. A largely swollen and broken hollow fiber were shown by disassemble examination of the nanofilter, and the loss of filtration function was found.

### INDUSTRIAL APPLICABILITY

According to the system for continuously using resist stripper liquid of the present invention, the frequency of replacing the stripper liquid in a process for the production of electronic components such as semiconductors, liquid crystal devices and printed wiring boards can be decreased, and the amount of the waste liquid and the amount of the use of the fresh stripper liquid can be decreased. Thus, the efficacy of the production of the electronic components can be improved and the production cost can be decreased.

### BRIEF DESCRIPTION OF DRAWINGS

FIG. 1 is a conceptual diagram of the resist stripping apparatus applying the system for continuously using resist stripper liquid of the present invention.

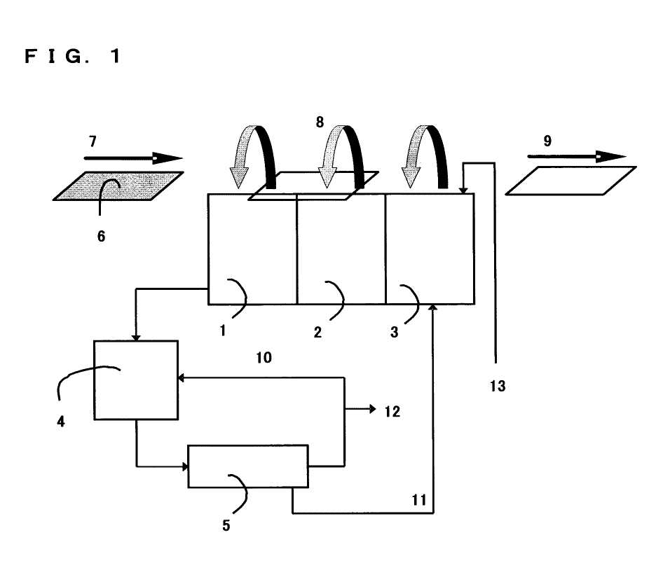

### DESCRIPTION OF REFERENCE NUMERALS AND SIGNS

1: Stripping tank 1
2: Stripping tank 2
3: Stripping tank 3
4: Tank for circulating the concentrated stripper liquid
5: Nanofilter
6: Substrate attached with a resist film
7: Supplying direction of substrate attached with a resist film
8: Resist stripping by showering the stripper liquid
9: Taking out of the substrate after stripping of the resist film
10: Concentrated stripper liquid
11: Treated stripper liquid
12: Partial discharge of the concentrated stripper liquid
13: Suppliance of the fresh stripper liquid

What is claimed is:

1. A resist stripping system characterized in that said system comprises a first step for stripping a positive type resist film using a resist stripper liquid containing 80% or more by weight of an organic compound based on 100% by weight of the total amount of said resist stripper liquid, and a second step for carrying out cross-flow filtration using a ceramic filter having a pore size of 2 to 5 nm and a fractional molecular weight of 1,000 to 4,000, and that a treated stripper liquid from which said resist component is removed at a condition of the stopping ratio of 70% or more in said second step is re-used in said first step to keep the concentration of said resist component in said resist stripper liquid in said first step at 2% or less by weight.

2. The resist stripping system according to claim 1,
wherein said resist stripper liquid does not comprise an amine and an alkali, and
wherein said resist stripper liquid has a pH in the range from 4 to 9.

3. The resist stripping system according to claim 1 or 2,
further comprising a third step for supplying the treated stripper liquid that was treated in the second step while adding a fresh stripper liquid containing no resists, and a fourth step for discharging from the system a concentrated stripper liquid in which the resist component is concentrated in said second step at regular time intervals or at a certain flow rate before re-supplying said concentrated stripper liquid to said second step.

4. The resist stripping system according to any one of claims 1 to 3,
wherein the flow rate of said stripper liquid in the direction parallel to the surface of said filter in the cross-flow filtration is in the range from 0.5 m/s to 4 m/s.

5. The resist stripping system according to any one of claims 1 to 4,
wherein said resist component is a component of a dissolved positive photoresist in said stripper liquid, said positive photoresist being in which a naphthoquinone diazide is added to a phenol novorac resin and/or a cresol novorac resin.
